(19) United States
(12) Patent Application Publication
(10) Pub. No.: US 2014/0344458 A1
(43) Pub. Date: Nov. 20, 2014

(54) Device and method for distributing load of server based on cloud computing

(71) Applicant: Korea University Research and Business Foundation, Seoul (KR)

(72) Inventors: Hee Jo Lee, Seoul (KR); Rashad Aliyev, Seoul (KR); Dong Won Seo, Anyang-si (KR); John Milburn, Palo Alto, CA (US)

(73) Assignee: Korea University Research and Business Foundation, Seoul (KR)

(21) Appl. No.: 14/120,288

(22) Filed: May 14, 2014

(30) Foreign Application Priority Data
May 14, 2013 (KR) 10-2013-0054530

(51) Int. Cl. H04L 12/917

(52) U.S. Cl. CPC H04L 47/76
USPC 709/226

(57) ABSTRACT

A load distribution device that distributes load of a target server is provided. The load distribution device includes a load detection unit that monitors a load amount of the target server and determines whether the load amount exceeds a predetermined critical value, a server driving unit that drives a replication server when the load amount exceeds the critical value, and a server control unit that distributes part of load to the replication server when the replication server has started to be driven. The replication server is implemented by a cloud computing technique.

### CROSS-REFERENCE TO RELATED APPLICATION

This application claims the benefit of Korean Patent Application No. 10-2013-0054530 filed on May 14, 2014, the disclosures of which are incorporated herein by reference.

### TECHNICAL FIELD

The embodiments described herein pertain generally to a device or method for defending traffic overload or DDoS attacks, and more particularly, to a device and a method for protecting a server from excessive network traffic utilizing cloud techniques.

### BACKGROUND

A Distributed-Denial-of-Service attack (hereinafter, referred to as “DDoS attack”) is one of hacking schemes that attacks a specific site by distributing and arranging a plurality of attackers to thereby simultaneously operate. The DDoS attack implants tools for service attack in a plurality of computers and enables a significantly huge amount of packets that a computer system of a site, an attack target, is incapable of processing to simultaneously flow, thereby degrading performance of a network or paralyzing the computer system.

Conventionally, a DDoS defense mechanism has been focused on protection of traffic using certain rules of the DDoS attacks. However, newly appearing types of DDoS attacks such as HTTP flood, Slowloris, RUDY, etc. have traffic patterns similar to normal ones, and, thus, a large amount of malicious traffic can still reach an attack target server even if such rules are applied. Further, if a defense mechanism based on such rules is used, normal traffic concentration such as flash crowds may be misidentified as malicious traffic.

In this regard, Korean Patent Laid-open Publication No. 10-2012-0066465 (entitled “Method for blocking a denial-of-service attack using an udp flooding”) describes a method for blocking DDoS attacks from traffic using certain rules.

### SUMMARY

In view of the foregoing, in order to solve the above-described problem, example embodiments provide a technique capable of continuously providing a service using a cloud replication server even when an overload of normal traffic or a DDoS attack occurs on a target server.

In accordance with a first aspect, a load distribution device that distributes load of a target server is provided. The load distribution device includes a load detection unit that monitors a load amount of the target server and determines whether the load amount exceeds a predetermined critical value, a server driving unit that drives a replication server when the load amount exceeds the critical value, and a server control unit that distributes part of load to the replication server when the replication server has started to be driven. The replication server is implemented by a cloud computing technique.

In accordance with a second aspect, a load distribution method of a load distribution device for distributing load of a target server is provided. The load distribution method includes monitoring a load status of the target server when the target server is driven and a service is provided, activating a replication server when a load amount of the target server exceeds a predetermined critical value, and distributing part of load of the target server to the replication server using a load distribution scheme when the replication server is activated. The replication server is implemented by a cloud computing technique.

In accordance with the various aspects and example embodiments, performance of an attack target server is not degraded due to a DDoS attack or a traffic overload, and the service provider can keep providing their services.

Further, in accordance with the various aspects and example embodiments, a false positive, in which a normal user is misidentified as a malicious user during traffic overload, and, thus, a service provided to a target server is stopped, is not generated.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 is a diagram for describing a filter propagation method as a conventional DDoS defense mechanism.

FIG. 2 is a diagram for describing an operation of a load distribution device in accordance with an example embodiment.

FIG. 3 illustrates a detailed configuration of a load distribution device of a target server in accordance with an example embodiment.

FIG. 4 illustrates an example of system construction of a server control unit to distribute traffic or a load in accordance with an example embodiment.

FIG. 5 is a flowchart for describing a method of a load distribution device for distributing traffic or a load of a target server in accordance with an example embodiment.

### DETAILED DESCRIPTION

Hereinafter, embodiments of the present disclosure will be described in detail with reference to the accompanying drawings so that the present disclosure may be readily implemented by those skilled in the art. However, it is to be noted that the present disclosure is not limited to the embodiments but can be embodied in various other ways. In drawings, parts irrelevant to the description are omitted for the simplicity of explanation, and like reference numerals denote like parts through the whole document.

Through the whole document, the term “connected to” or “coupled to” that is used to designate a connection or coupling of one element to another element includes both a case that an element is “directly connected or coupled to” another element and a case that an element is “electronically connected or coupled to” another element via still another element. Further, the term “comprises or includes” and/or “comprising or including” used in the document means that one or more other components, steps, operation and/or existence or addition of elements are not excluded in addition to the described components, steps, operation and/or elements unless context dictates otherwise.

Through the whole document, the term “step of” does not mean “step for”.

Through the whole document, the term “traffic” means a load given to a certain communication device or system unless context dictates otherwise.

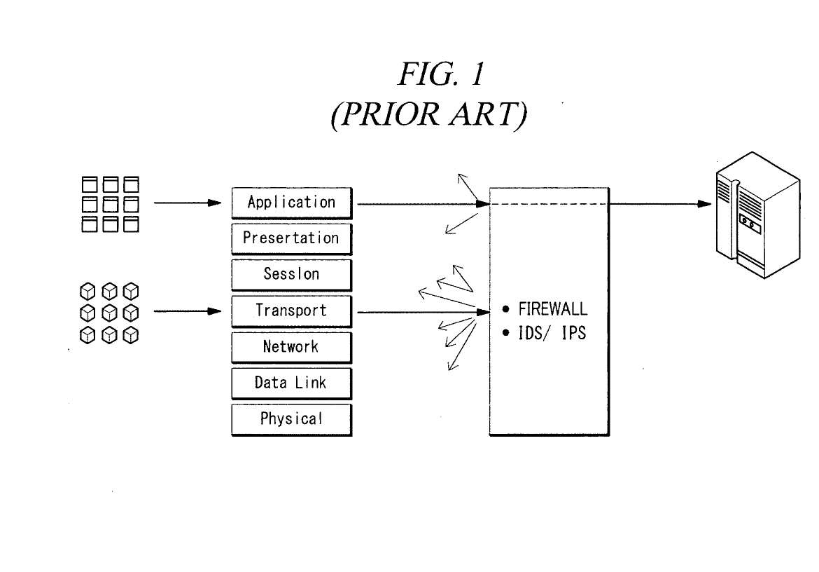

FIG. 1 is a diagram for describing a filter propagation method as a conventional DDoS defense mechanism.

A filter propagation method as a conventional DDoS defense mechanism has been focused on defending an attack target server by installing a firewall or an IDS/IPS (Intrusion Detection/Protection System).

However, in the case of a new malicious attack in the form similar to a normal state or in the case of normal and temporary traffic concentration, excessive traffic is concentrated on a target server, resulting in a service fault of the server.

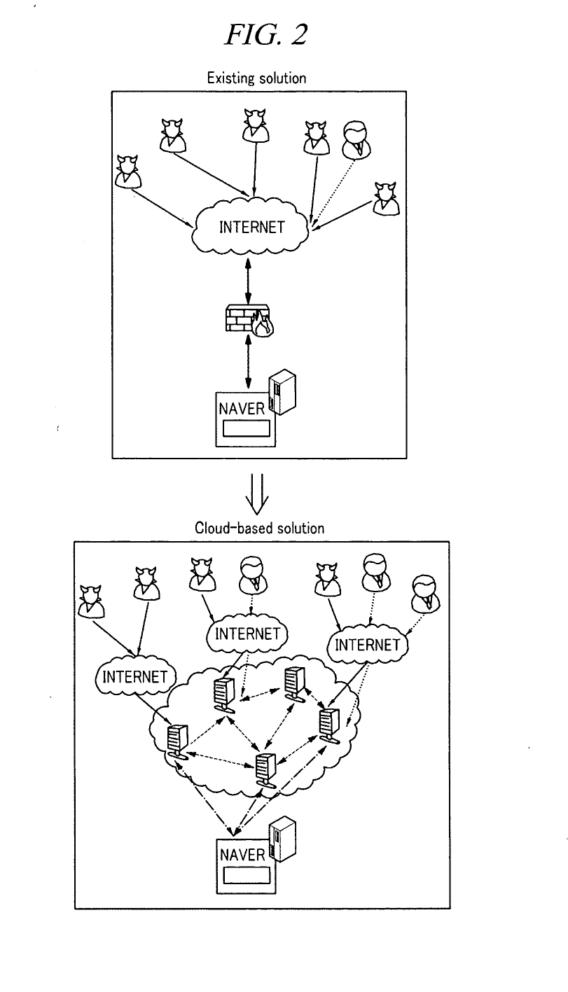

FIG. 2 is a diagram for describing an operation of a load distribution device in accordance with an example embodiment. According to the conventional method, a route from a user to a target server is limited. However, in accordance with the present disclosure, replication servers distributed in several sites provide services instead of the target server, and, thus, a route from a user to the target server is diversified and most of traffic does not reach the target server.

In order to solve the conventional problem, in the present disclosure, replication servers that perform the same function as the target server are constructed using cloud techniques, and when excessive traffic is concentrated on the target server, the traffic is distributed to the replication servers, and, thus, a service can be continuously provided.

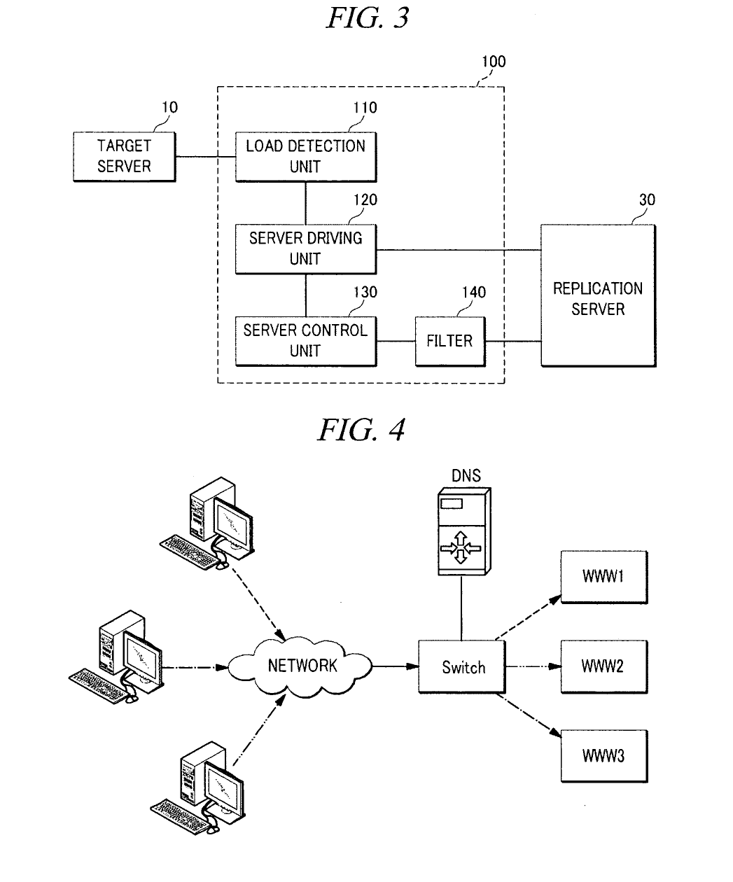

FIG. 3 illustrates a detailed configuration of a load distribution device of a target server in accordance with an example embodiment.

A load distribution device 100 includes a load detection unit 110, a server driving unit 120, a sever control unit 130, and a filter 140.

The load detection unit 110 monitors a load amount of a target server 10 and determines whether or not traffic concentration occurs on the target server 10. In accordance with an example embodiment, the load detection unit 110 can determine whether or not traffic concentration occurs based on whether or not a load amount of the target server 10 exceeds a predetermined critical value. In accordance with the example embodiment, the critical value can be determined by a service provider in preparation for a DDoS attack that makes it impossible for a system to provide a normal service any more by distributing and arranging multiple attackers to thereby simultaneously make denial of service (DoS) attacks. Further, in order to provide a higher quality service, the service provide may set a critical value to be low such that a load amount over a certain level can be detected.

The server driving unit 120 drives a replication server 30 for distribution of a load when traffic concentration occurs.

Further, when the replication server 30 is driven according to an operation of the server driving unit 120, the server control unit 130 distributes traffic or a load to the replication server 30.

The replication server 30 can be implemented by a cloud computing technique. However, the replication server 30 is not necessarily implemented by the cloud computing technique, but can be configured as a separate internal or external resource. The cloud computing technique is a technique of virtually integrating resources of computers present in different physical locations, and, thus, makes it possible to efficiently use a resource of the replication server 30. In accordance with the present disclosure, the replication server 30 can be constructed using a resource of a server in a virtual space.

The replication server 30 driven by the server driving unit 120 is classified into three types depending on a construction scheme.

Firstly, the replication server 30 can be configured by replicating the whole content of the target server 10 into the replication server, which takes a long time to replicate and requires a lot of resources of a storage device, but most stably provides a service to a user.

Secondly, the replication server can be configured by replicating a specific content frequently requested by a user into the replication server. Such an interest-based replication server can determine whether a content is frequently requested by the user based on the number of user requests for the content. The interest-based replication server requires relatively less resources, but a service provider needs to monitor which content users have been interested in, and update content of the replication server accordingly.

Finally, a content type-based replication server classifies content into multimedia files, text files, user files, and the like, and then stores the classified content in the replication server. That is, a replication server is in charge of one or more content types. Herein, the content type may refer to a file format, a predefined category or the like of a content.

The server control unit 130 may use the following method as a method of distributing traffic or a load to the replication server 30.

A DNS-based load distribution method dynamically uses DNS Round Robin depending on the situation. DNS Round Robin is one of techniques of distributing a service to multiple servers using a DNS (Domain Name System). By way of example, if a server having an IP address of 1.1.1.1 is in charge of a service regarding www.example.com, when excessive traffic is concentrated, IP addresses of 1.1.1.2, 1.1.1.3, etc. of the replication servers 30 are additionally registered as servers in charge of the corresponding domain, so that traffic of a user can be distributed to the replication servers 30.

A network switch has a function of delivering a packet having a specific IP range as a source IP address or a packet selected with a certain probability to a specified target. A switch-based load distribution method distributes traffic to the replication server 30 using such a function.

FIG. 4 illustrates an example of system construction of a server control unit to distribute traffic or a load in accordance with an example embodiment. By way of example, www1 is a web server, and www2 and www3 are replication servers that perform the same function as www1. Traffic toward www1 from users can be distributed to www2 and www3 by DNS Round Robin, a packet delivery function of a switch, or others.

A network can be implemented in a wired network such a Local Area Network (LAN), a Wide Area Network (WAN), or a Value-Added Network (VAN), or all kinds of wireless network such as mobile radio communication network or a satellite communication network.

The present disclosure may further include a filter 140. A filter in accordance with an example embodiment is a component configured to process traffic generated by a malicious code among traffic to be distributed to the replication server by the sever control unit 130. The filter 140 is a component configured to distribute traffic to the replication server when the target server 10 is attacked by a malicious code, and also to perform an extra process regarding the malicious code.

In accordance with an example embodiment, the server driving unit 130 can inactivate the replication server 30 when traffic concentration is ended, i.e. when a load amount does not exceed a predetermined critical value.

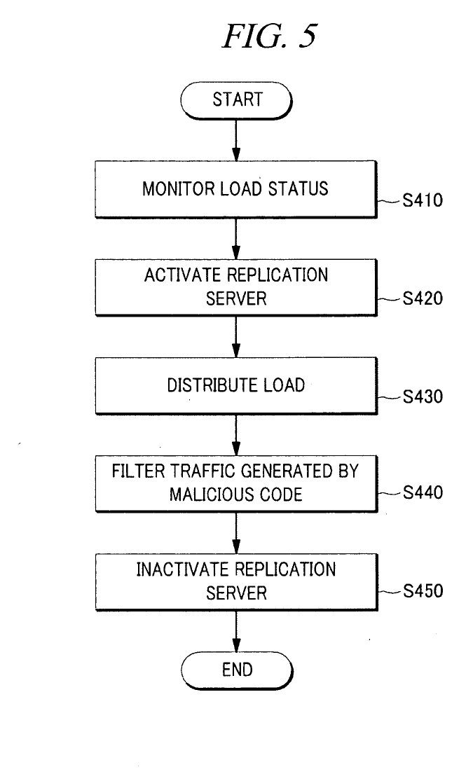

FIG. 5 is a flowchart for describing a method of a load distribution device for distributing traffic or a load of a target server in accordance with an example embodiment.

When a target server is being driven and a service is provided, a load distribution device monitors a load status of the target server (S410).

Then, in the case of normal traffic concentration such as flash crowds referring to a phenomenon in which after a DDoS attack or a some interesting event or announcement occurs, the number of people accessing a relevant site suddenly increases, a replication server is activated (S420).

In accordance with an example embodiment, whether or not traffic concentration occurs can be determined based on whether or not a load amount of the target server exceeds a predetermined critical value.

The activated replication server can be classified into three types: a whole replication server; an interest-based replication server; and a content type-based replication server, depending on a construction scheme.

Firstly, a replication server can be configured by replicating the whole content of a target server into the replication server, which takes a long time to replicate and requires a lot of resources of a storage device, but most stably provides a service to a user.

Secondly, a replication server can be configured by replicating a specific content frequently requested by a user into the replication server. Such an interest-based replication server can determine whether a content is frequently requested by the user based on the number of user requests for the content. The interest-based replication server requires relatively less resources, but a service provider needs to monitor which content users have been interested in, and update content of the replication server accordingly.

If a replication server is configured as an interest-based replication server, before the replication server is activated (S420), a step of checking whether the user-requested content has been replicated into the interest-based replication server may be further included in order to redistribute the load caused by the request of the user for the interest-based content into the replication server.

Finally, a content type-based replication server classifies content into multimedia files, text files, user files, and the like, and then stores the classified content in the replication server. That is, a replication server is in charge of one or more content types. Herein, a content type may be a file format, a predefined category or the like of a content.

If a replication server is configured as a content type-based replication server, before the replication server is activated (S420), a step of checking the type of the user-requested content may be further included, and in a step of distributing a load (S430) to be described later, a load of the target server can be distributed in order to redistribute a load to each replication server depending on a type of user content.

The replication server 30 can be implemented by a cloud computing technique. However, the replication server 30 is not necessarily implemented by the cloud computing technique, but can be configured as a separate internal or external resource. The cloud computing technique is a technique of virtually integrating resources of computers present in different physical locations, and, thus, makes it possible to efficiently use a resource of the replication server 30. In accordance with the present disclosure, the replication server 30 can be constructed using a resource of a server in a virtual space.

Then, a load is distributed using a load distribution scheme (S430). The following method may be used as a method of distributing a load.

A DNS-based load distribution method dynamically uses DNS Round Robin and a client characteristic-based method depending on the situation. According to the DNS Round Robin, it is possible to distribute a service to multiple servers using a DNS (Domain Name System). Using the client characteristic-based method, it is possible to distribute clients to multiple servers based on their characteristics.

A network switch has a function of delivering a packet having a specific IP range as a source IP address or a packet selected with a certain probability to a specified target. A switch-based load distribution method distributes traffic to a replication server using such a function.

Then, in accordance with an example embodiment, a process of known malicious traffic can be determined using a filter (S440).

Thereafter, in accordance with an example embodiment, a load status of the target server is continuously monitored, and when traffic overload on the target server is ended, the replication server is inactivated (S450).

According to the load distribution device or the load distribution method in accordance of the present disclosure, performances of an attacked target server is not degraded due to a DDoS attack or traffic overload, and the service provider can provide their services without service fault. Further, a false positive, in which a normal user is misidentified as a malicious user during traffic overload, and, thus, a service provided to a target server is stopped, is not generated.

For reference, each of components illustrated in FIG. 3 in accordance with an example embodiment may imply software or hardware such as a field programmable gate array (FPGA) or an application specific integrated circuit (ASIC), and they carry out a predetermined function.

However, the components are not limited to the software or the hardware, and each of the components may be stored in an addressable storage medium or may be configured to implement one or more processors.

Accordingly, the components may include, for example, software, object-oriented software, classes, tasks, processes, functions, attributes, procedures, sub-routines, segments of program codes, drivers, firmware, micro codes, circuits, data, database, data structures, tables, arrays, variables and the like.

The components and functions thereof can be combined with each other or can be divided.

The illustrative embodiments can be embodied in a storage medium including instruction codes executable by a computer or processor such as a program module executed by the computer or processor. A data structure in accordance with the illustrative embodiments can be stored in the storage medium executable by the computer or processor. A computer readable medium can be any usable medium which can be accessed by the computer and includes all volatile/non-volatile and removable/non-removable media. Further, the computer readable medium may include all computer storage and communication media. The computer storage medium includes all volatile/non-volatile and removable/non-removable media embodied by a certain method or technology for storing information such as computer readable instruction code, a data structure, a program module or other data. The communication medium typically includes the computer readable instruction code, the data structure, the program module, or other data of a modulated data signal such as a carrier wave, or other transmission mechanism, and includes information transmission mediums.

The load distribution device and method in accordance with the present disclosure can be implemented by a computer-readable code in a computer-readable storage medium. The computer-readable storage medium includes all kinds of storage media in which computer-readable data are stored and may include, for example, a ROM (Read Only Memory), a RAM (Random Access Memory), a magnetic tape, a magnetic disc, a flash memory, an optical data storage device, etc. Further, the computer-readable storage medium can be distributed in a computer system connected via a computer communication network and can be stored and executed as a code that is readable in a distribution manner.

The device and method of the present disclosure has been explained in relation to a specific embodiment, but its components or a part or all of its operation can be embodied by using a computer system having general-purpose hardware architecture can be applied.

The above description of the present disclosure is provided for the purpose of illustration, and it would be understood by those skilled in the art that various changes and modifications may be made without changing technical conception and essential features of the present disclosure. Thus, it is clear that the above-described embodiments are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

We claim:

1. A load distribution device that distributes a load of a target server, the load distribution device comprising:
a load detection unit that monitors a load amount of the target server and determines whether the load amount exceeds a predetermined critical value;
a server driving unit that drives a replication server when the load amount exceeds the critical value; and
a server control unit that distributes part of load to the replication server when the replication server has started to be driven,
wherein the replication server is implemented by a cloud computing technique.

2. The load distribution device of claim 1,
wherein the server driving unit drives a whole replication server into which whole content of the target server has been replicated.

3. The load distribution device of claim 1,
wherein the server driving unit drives an interest-based replication server into which part of content frequently requested by a user more than certain number of times has been replicated from the target server.

4. The load distribution device of claim 1,
wherein the server driving unit drives a content type replication server into which part of content classified by content type has been replicated from the target server.

5. The load distribution device of claim 1,
wherein the server control unit distributes a load of the target server by a DNS distribution method in which part of load is distributed using a DNS, or using a switch-based load distribution method in which packets selected with a certain probability is delivered to a specified target.

6. The load distribution device of claim 1, further comprising:
a filter that processes traffic generated by a malicious code, among traffic to be distributed to the replication server by the server control unit.

7. The load distribution device of claim 1,
wherein the server driving unit inactivates the replication server when the load amount does not exceed the critical value.

8. A load distribution method of a load distribution device for distributing a load of a target server, the load distribution method comprising:
monitoring a load status of the target server when the target server is driven and a service is provided;
activating a replication server when a load amount of the target server exceeds a predetermined critical value; and
distributing part of load of the target server to the replication server using a load distribution scheme when the replication server is activated,
wherein the replication server is implemented by a cloud computing technique.

9. The load distribution method of claim 8,..
wherein the activating of the replication server includes activating a whole replication server into which whole content of the target server has been replicated.

10. The load distribution method of claim 8,
wherein the activating of the replication server includes activating an interest-based replication server into which part of content frequently requested by a user more than certain number of times has been replicated from the target server.

11. The load distribution method of claim 8,
wherein the activating of the replication server includes activating a content type replication server into which part of content classified by content type has been replicated from the target server, and
the distributing of the load includes distributing part of load of the target server depending on the content type.

12. The load distribution method of claim 8,
wherein the distributing of the load includes distributing part of load by a DNS distribution method in which the part of load is distributed using a DNS, or using a switch-based load distribution method in which packets selected with a certain probability is delivered to a specified target.

13. The load distribution method of claim 8, further comprising:
filtering traffic generated by a malicious code, among traffic to be distributed to the replication server.

14. The load distribution method of claim 8, further comprising:
inactivating the replication server when the load amount of the target server does not exceed the critical value.
